(19) United States
(12) Patent Application Publication
(10) Pub. No.: US 2013/0219811 A1
(43) Pub. Date: Aug. 29, 2013

(54) RAISED ACCESS FLOOR

(71) Applicants: YEN-CHUN WANG, NEW TAIPEI CITY (TW); PONG-PING WANG, NEW TAIPEI CITY (TW)

(72) Inventors: YEN-CHUN WANG, NEW TAIPEI CITY (TW); PONG-PING WANG, NEW TAIPEI CITY (TW)

(73) Assignee: UNITED INTEGRATED SERVICES CO., LTD., NEW TAIPEI CITY (TW)

(21) Appl. No.: 13/405,382

(22) Filed: Feb. 27, 2012

(51) Int. Cl. E04B 1/92; G21F 7/00; E04B 5/43

(52) U.S. Cl. 52/173.1; 52/220.1

(57) ABSTRACT

The instant disclosure relates to a raised access floor having electromagnetic shielding capability. The access floor is made of a metallic material. The access floor includes a load-bearing member and a shielding member interconnected to each other. The access floor of the instant disclosure can further include a load-bearing member made of a material having electromagnetic shielding and load-bearing capabilities.

### BACKGROUND OF THE INVENTION

1. Field of the Invention

The instant disclosure relates to a raised access floor; in particular, to an access floor having electromagnetic shielding capability.

2. Description of Related Art

Along with the advance of technology, the non-ionizing radiation induced from electrical conductors has also increased simultaneously. However, the non-ionizing radiation may cause electromagnetic interference to machines with high electromagnetic-sensitivity in the high-tech factories. Moreover, epidemiological study suggests an exposure-response relationship between, magnetic-flux density and leukemia. Other health risks include the suppression of melatonin secretion and cancer. Therefore, the study of how to reduce magnetic-flux density in the free space is absolutely essential. The amount of magnetic-flux density depends on the number of electric wires/cables, how the wires are arranged, the distance between the wires, and the amount of the current passing through the wires. In the case of a typical raised access floor, the electromagnetic shielding effect is poor. To add an electromagnetic shield after the raised access floor has already been installed is rather difficult labor-wise. Another option is to add strips of silicon steel to the raised access floors. However, this method is labor intensive, and the strips tend to warp over time. The arrangement of cables may also become more challenging.

### SUMMARY OF THE INVENTION

The object of the instant disclosure is to provide a raised access floor having electromagnetic shielding capability. This raised access floor can be easily installed without interfering the cables.

To achieve the aforementioned object, the raised access floor provided by the instant disclosure is made of a metallic material. The raised access floor includes a load-bearing member interconnected to a shielding member.

The instant disclosure further provides a raised access floor capable of providing electromagnetic shielding effect. The raised access floor includes a load-bearing member, where the load-bearing member is made of a material having electromagnetic shielding and load-bearing capability.

The instant disclosure has the following advantages:

Being made of materials having electromagnetic shielding characteristic such as steel or its variant (e.g., silicon steel), the raised access floor of the instant disclosure can be easily constructed, does not warp, and does not incur any inconvenience in arranging the cables.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a perspective view of a raised access floor according to a first embodiment of the instant disclosure;

FIG. 2 shows a perspective view of a raised access floor according to a second embodiment of the instant disclosure;

FIG. 3 shows a perspective view of a raised access floor according to a third embodiment of the instant disclosure;

FIG. 4 shows a perspective view of a raised access floor according to a fourth embodiment of the instant disclosure.

### DETAILED DESCRIPTION OF THE PREFERRED EMBODIMENTS

The raised access floor of the instant disclosure can be made with conductive or magnetic load-bearing metallic material having inherent electromagnetic shielding capability. (please refer to Taiwan Patent No. M373949 of the same inventor, and China Patent No. ZL200920175137.5). Then, based on the shielding requirement, additional silicon steel plates can be added to meet the requirement. The main focus of the instant disclosure is the utilization of steel-based raised access floor having electromagnetic shielding capability. However the instant disclosure is not limited to the following examples, all descriptions illustrated in the following shall fall under the claim scope of the instant disclosure.

When magnetic lines of flux encounter a shielding material, part of the magnetic forces are absorbed by the material. The amount of absorption depends very much upon the material used, its thickness, and the frequency of the magnetic field of interest. The absorption loss, denoted by the letter “A” and measured in decibels (dB), is calculated by the following expression: A=131.4 t(fμσ)^{1/2}. The variables are defined as follow: t is the thickness of the material (mm); f is the frequency of the magnetic field (MHz); μ is the relative permeability of the material (i.e., the ratio of the permeability of the material to the permeability of free space); and σ is the relative electrical conductivity of the material (i.e., the ratio of the conductivity of the material to the conductivity of copper).

The mechanism of shielding is done by using a shielding member made of a material having high magnetic permeability. Because the shielding member offers a less magnetic resistance, the shielding member acts as a low reluctance path for the magnetic flux about the conductors thereby diverting the flux away from the region beyond the raised access floor. Furthermore, to optimize the shielding effect, the electric cables underneath the raised access floor can be rerouted, and the distance between the cables and people walking on the floor can be increased.

In terms of the degree of shielding capability for various materials, for having substantially the same thickness and exposed under the same magnetic field frequency, is ranked as follows: permalloy>ferromolybdenum>silicon steel>pure iron>carbon steel>aluminum>copper. Most of the conventional raised access floors are made of materials such as synthetic polymers, wood, or aluminum alloy, for they can be easily processed. The permeability of these materials, however, is far less than various types of steel up to a thousand times. For instance, the relative permeability of the raised access floor made of cast aluminum alloy is 1, while the relative permeability of the raised access floor made of steel is 1000. For substantially the same material thickness and magnetic field frequency, the amount of magnetic energy absorbed by the steel floor is approximately thirty times greater than the energy absorbed by the aluminum floor. In other words, the conventional raised access floors have neglected the importance of magnetic shielding capability provided by materials such as steel and silicon steel.

The physical characteristics of the raised access floor having electromagnetic shielding capability of the instant disclosure are described hereinbelow:

The access floor is made of a metallic material having electromagnetic shielding capability. The access floor is raised to keep a predetermined distance from the ground and away from the source of the magnetic field. Furthermore, materials with high permeability can also be included in the access floor to increase the electromagnetic shielding effect thereof. More specifically, the material having electromagnetic shielding capability also serves as the load-bearing material for the access floor. If necessary, additional silicon steel plates can be added to the access floor to meet the electromagnetic shielding requirement. For example, silicon steel or other types of steel material can be chosen as the dual-purpose load-bearing and electromagnetic shielding material for the access floor. This dual-purpose material can further be combined to a material having high permeability. Specifically speaking, the high permeability material can be disposed above and/or below the steel-based structure.

The abovementioned high permeability material can be a silicon steel plate. Other criteria, such as magnetic field frequency or magnetic-flux density, can be taken into consideration while selecting the high permeability material.

In order to be aesthetically appealing, conductive PVC tile or plain PVC tile can be disposed on the surface of the access floor (i.e., the high permeability material). The access floor having a wooden skin is also desirable.

The abovementioned metallic material may be a ferromagnetic or paramagnetic material.

Method such as gluing, spot welding, or screw-fastening may be used to secure the high permeability material to the steel-based structure.

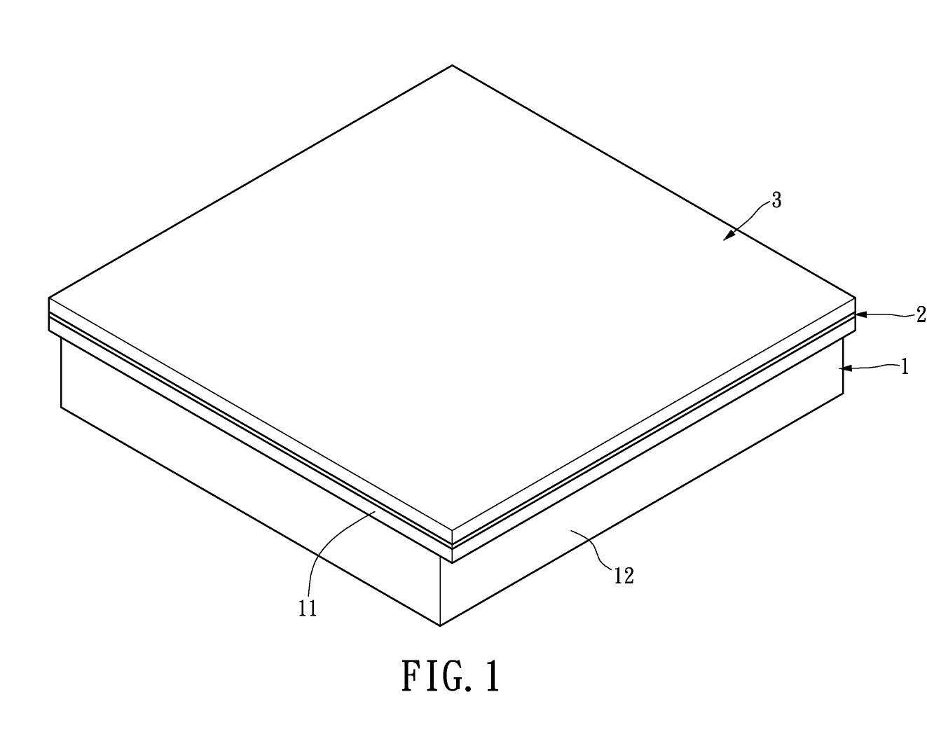

The instant disclosure provides a raised access floor having electromagnetic shielding effect. The access floor is made of a metallic material such as iron or aluminum, but is not limited thereto. The access floor is raised from the ground by a predetermined distance, and the access floor is capable of providing electromagnetic shielding effect and load-bearing ability. Furthermore, the load-bearing structure of the access floor can further include high permeability material as shown in FIG. 1.

The instant disclosure provides another raised access floor having electromagnetic shielding capability. The access floor is made of a metallic material such as silicon steel or other steel-based material. The metallic material is capable in providing both electromagnetic shielding and load-bearing abilities. A composite steel material may also be used to construct the access floor, but is not restricted thereto. For example, the access floor can be entirely made of a silicon steel, an iron-silicon steel composite material, an aluminum alloy-silicon steel composite material, or other silicon steel composite material. It is worth noting the material used to construct the access floor of the instant disclosure is not limited to the aforementioned examples. However, all aforementioned examples fall under the claim scope of the instant disclosure.

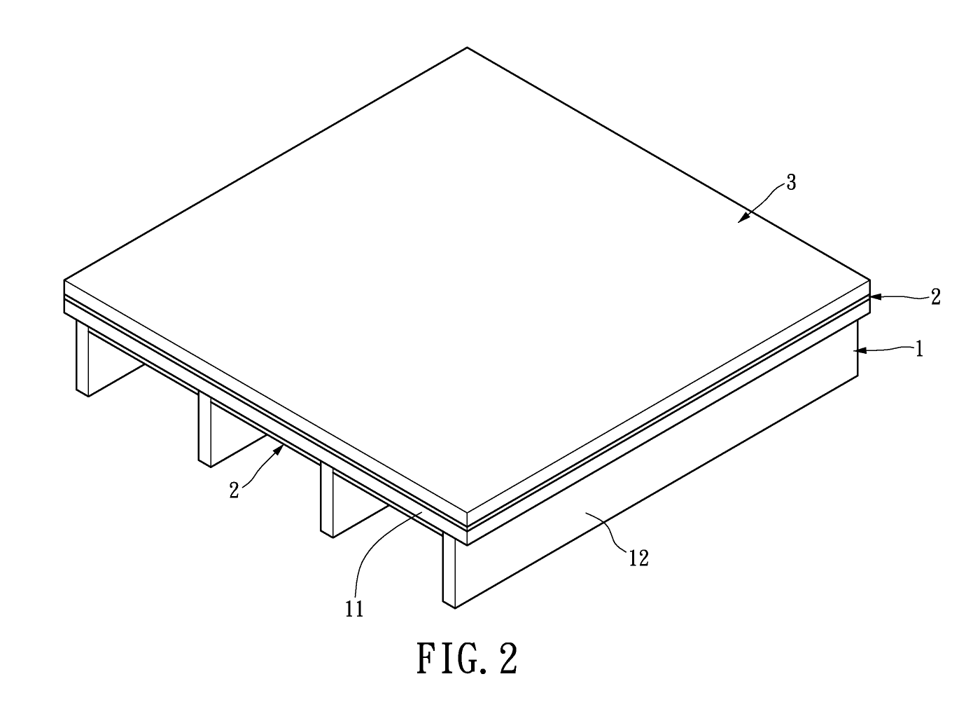

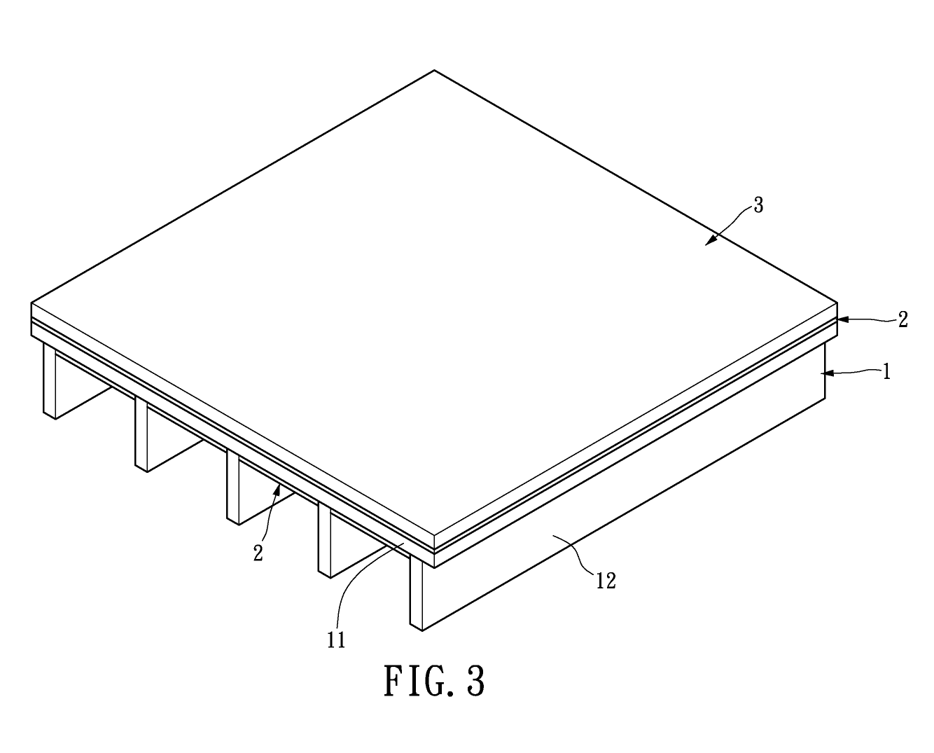

The instant disclosure provides yet another access floor having electromagnetic shielding capability. The access floor has a load-bearing structure made of a high conductivity or high permeability material. Moreover, additional electromagnetic shielding materials can be added to the load-bearing structure to form a substantially sandwich-like access floor. The additional electromagnetic shielding material can be arranged above and/or below the load-bearing structure. An example of the access floor having silicon steel plates is shown in FIGS. 2 and 3.

The instant disclosure provides still another access floor having electromagnetic shielding capability. Additional high permeability material is further added to the access floor. The selection of the high permeability materials may depends on the magnetic field frequency or the magnetic-flux density. The high permeability material may be directional silicon steel plate, non-directional silicon steel plate, permalloy, ferromolybdenum, carbon steel plate, copper foil, or conductive coating, but are not restricted thereto.

Please refer to FIGS. 1˜3, which show various types of the raised access floor having electromagnetic shielding capability of the instant disclosure. It is worth noting the access floor of the instant disclosure is not restricted to the embodiments shown in the figures, but instead can be adjusted in accordance to the actual needs. FIG. 1 shows an access floor having electromagnetic shielding capability for a first embodiment of the instant disclosure. The access floor may be made of a metallic ferromagnetic material or a metallic paramagnetic material. An example of the ferromagnetic material is iron, while paramagnetic material such as aluminum or aluminum alloy may be used. However, the material of the access floor is not restricted to iron or aluminum/aluminum alloy. The access floor includes a load-bearing member 1 and a shielding member 2 connected to each other. The load-bearing member 1 can be made of steel or silicon steel. This steel or silicon steel structure provides both load-bearing and electromagnetic shielding capabilities. The load-bearing member 1 includes a panel 11 and a support 12. The panel 11 and the support 12 can be integrally formed as a single unit or assembled together as separate pieces. The shielding member 2 can be made of a high permeability material such as steel or silicon steel and disposed on the load-bearing member 1. In other words, the shielding member 2 can be disposed above or below the panel 11 of the load-bearing member 1. For the instant embodiment, the shielding member 2 is disposed above the panel 11 of the load-bearing member 1 for the orientation shown FIG. 1. The load-bearing member 1 and the shielding member 2 can be connected to each other by gluing, spot welding, or screw fastening. The shielding member 2 acts solely as a shielding structure. The outer surface of the access floor can further be topped by a conductive tile 3. The conductive tile 3 can be made of a plastic material such as PVC and disposed on the shielding member 2.

Please refer to FIGS. 2 and 3, which show an access floor having electromagnetic shielding capability for a second and third embodiments of the instant disclosure, respectively. In both cases, the load-bearing structure itself of the access floor is made of a high electrical conductivity or high permeability material, and an extra shielding material is added to the load bearing structure to form a substantially sandwich-like access floor. This shielding material can be disposed above and/or below the load-bearing member 1. As shown in FIGS. 2 and 3, additional shielding members 2 are arranged on the bottom surface of the panel 11 of the load-bearing member 1. For the case where a silicon steel shielding member is used, the effectiveness of this type of shielding is measured experimentally. For different arrangements of the shielding member 2, such as above or/and below the load-bearing member 1, the measured shielding efficiency can reach up to 74%˜98.3%.

In addition, if better air ventilation is in demand, in order to provide electromagnetic shielding effect and air ventilation, a honeycomb plate can be used as the shielding member 2.

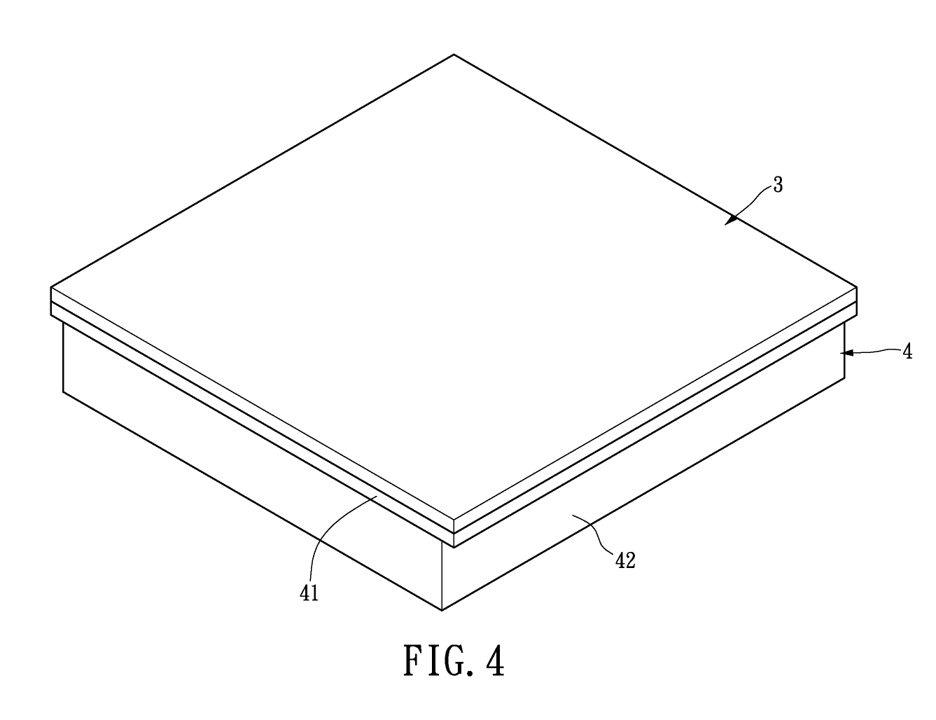

Please refer to FIG. 4, which shows an access floor having electromagnetic shielding capability for a fourth embodiment of the instant disclosure. The access floor of the instant embodiment includes a load-bearing member 4. The load-bearing member 4 includes a panel 41 and a support 42. The panel 41 and the supporting 42 can be integrally formed as a single unit or assembled together as separate pieces. Similarly, the outer surface of the access floor can further be topped by the conductive tile 3. The conductive tile 3 can be made of a plastic material such as PVC and disposed on the load-bearing member 4. The load-bearing member 4 is made of a material having electromagnetic shielding and load-bearing capabilities, such as silicon steel, steel, iron-silicon steel composite, or aluminum alloy-silicon steel composite.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A raised access floor having electromagnetic shielding capability, wherein the access floor is made of a metallic material, and wherein the access floor includes a load-bearing member and a shielding member connected thereto.

2. The raised access floor having electromagnetic shielding capability of claim 1, wherein the load-bearing member is constructed with a high permeability material.

3. The raised access floor having electromagnetic shielding capability of claim 1, wherein the shielding member is made of a material selected from a group consisting of silicon steel, steel, and composite silicon-iron steel.

4. The raised access floor having electromagnetic shielding capability of claim 1, wherein the shielding member is disposed on at least one surface of the load-bearing member.

5. The raised access floor having electromagnetic shielding capability of claim 1, wherein the shielding member is selected from a group consisting of directional silicon steel plate, non-directional silicon steel plate, permalloy, ferromolybdenum, carbon steel plate, copper foil, and conductive coating.

6. The raised access floor having electromagnetic shielding capability of claim 1, wherein a PVC conductive tile, a PVC tile, or a wooden skin is disposed on a surface of the access floor.

7. The raised access floor having electromagnetic shielding capability of claim 1, wherein the metallic material is selected from a group consisting of ferromagnetic material and paramagnetic material.

8. The raised access floor having electromagnetic shielding capability of claim 1, wherein the connection means between the load-bearing member and the shielding member is selected from a group consisting of gluing, spot welding, and screw fastening.

9. The raised access floor having electromagnetic shielding capability of claim 1, wherein the shielding member is a honeycomb plate.

10. A raised access floor having electromagnetic shielding capability, wherein the access floor includes a load-bearing member made of a material having electromagnetic shielding and load-bearing capabilities.

11. The raised access floor having electromagnetic shielding capability of claim 10, wherein the material having electromagnetic shielding and load-bearing capabilities is selected from a group consisting of silicon steel and steel.

12. The raised access floor having electromagnetic shielding capability of claim 10, wherein the material having electromagnetic shielding and load-bearing capabilities is selected from a group consisting of composite silicon-iron steel and composite aluminum alloy-silicon steel.

13. The raised access floor having electromagnetic shielding capability of claim 10, wherein silicon steel is selected as the material having electromagnetic shielding and load-bearing capabilities for integrally forming a silicon steel structure.
